(19) United States
(12) Patent Application Publication
(10) Pub. No.: US 2009/0188684 A1
(43) Pub. Date: Jul. 30, 2009

(54) Land Clearing Rake

(76) Inventor: Marlin Parrish, Kingwood, TX (US)

Correspondence Address: NICK TAYLOR, 3440 BELL, SUITE 320, #221, AMARILLO, TX, 79109, US

(21) Appl. No.: 12/209,186

(22) Filed: Sep. 11, 2008

Related U.S. Application Data
(63) Continuation-in-part of application No. 11/333,490, filed on Jan. 17, 2006, now abandoned.

(51) Int. Cl. A01B 31/00; A01B 23/02; E02F 3/815

(52) U.S. Cl. 172/684.5; 172/716; 172/701.1; 172/714

(57) ABSTRACT

The invention is a land clearing rake that is typically mounted on a moldboard on a conventional bulldozer. The land clearing rake pivots about a shaft that is horizontally connected to the front of the moldboard. The rake is comprised of teeth connected to each other by heavy-duty plates between each of the teeth. The teeth may be arranged in one or more sections wherein the sections can be simultaneously raised or lowered by winches mounted on the moldboard. The winches are remotely controlled from the operator's seat. Thus, the land clearing rake is capable of being quickly raised or lowered by the operator while the earth moving equipment is moving back to prepare for another forward move. The ability to quickly transition between raking and grading modes significantly improves the efficiency of land clearing operations.

### CROSS-REFERENCE TO RELATED APPLICATION

This application is a continuation-in-part of application Ser. No. 11/333,490 filed Jan. 17, 2006.

### FIELD OF THE INVENTION

This invention relates to attachments for earth moving equipment, such as bulldozers, front-end loaders, skidders, graders, and the like. More particularly, this invention relates to a set of raking teeth that are pivotally secured to a moldboard used on heavy equipment, such as a bulldozer or other earth moving equipment.

### BACKGROUND OF THE INVENTION

Bulldozers with planar moldboards, or blades, mounted on the front are commonly used in a variety of land clearing applications including raking and grading. In raking applications, roots, limbs, and other undesirable debris are removed from an area. For grading applications, the lower edge of the moldboard is scraped along a surface in order to smooth or level the land. In order to perform the raking operation, bulldozers sometimes rely upon attachments with protruding teeth to serve as a rake. These teeth may be an integral feature of a specialized moldboard that protrude beyond the lower edge of the moldboard or the teeth may be a pivoting fixture attached to the moldboard that may be deployed or undeployed without removal.

Bulldozer moldboards with integral teeth tend to limit the use of the bulldozer to either a raking mode or a grading mode. Typically, in order to change between modes, one moldboard is completely removed and a different moldboard installed. The time to perform this somewhat cumbersome task is usually significant and results in unwanted down time for the equipment. Separate bulldozers could be used to avoid changeover time, but this practice is often economically impractical. Another disadvantage of this approach is that the additional moldboard to be used must be moved from one work site to the next. To accommodate the additional moldboard, additional trailer space for transportation is necessitated.

In many cases, the prior art utilizes a pivoting fixture attached to the moldboard that allows the teeth to be deployed or undeployed without removal. In some cases, the time and effort required to transition between the deployed and undeployed positions is significant. In other cases, the time and effort required to transition between the deployed and undeployed positions may be reduced, but the assembly may not always provide a method to place the teeth in a position that minimizes interference with the use of the moldboard. There is a need for an earth moving device that overcomes the shortcomings of the prior art.

### BRIEF DESCRIPTION OF THE DRAWINGS

FIG. 1 is an isometric view of a land clearing rake mounted on a bulldozer moldboard in the deployed position, according to some embodiments;

FIG. 2 is a frontal view of the land clearing rake (of FIG. 1) mounted on a bulldozer moldboard in the deployed position, according to some embodiments;

FIG. 3 is a two-dimensional side view of the land clearing rake (of FIG. 1) mounted on a bulldozer moldboard in the deployed position (with dashed lines illustrating the undeployed position), according to some embodiments;

FIG. 4 is a cutaway view of the right side (as viewed from the front of the bulldozer) of the hinge assembly of the land clearing rake, according to some embodiments.

FIG. 5 is side view of a tooth (typical) of the land clearing rake, according to some embodiments.

FIG. 6 is a flow diagram for a method to perform a land clearing operation, according to some embodiments.

### DETAILED DESCRIPTION

According to the embodiments described herein, a land clearing rake is disclosed. The land clearing rake includes a set of heavy-duty teeth that are specifically contoured for efficient raking of roots and other land clearing debris when the rake is in the deployed position. The rake teeth pivot about a shaft that is horizontally connected to the front of the dozer moldboard, or blade, near the midpoint of the dozer moldboard. The land clearing rake teeth are connected to each other by means of heavy-duty plates between each of the teeth.

The disclosed land clearing rake may attain many configurations. In one embodiment, the invention involves two sections of teeth and plates. In this embodiment, the two teeth near the center of the dozer moldboard are not connected to each other by plates. The sections are hinged at the center-point on the front of the moldboard and can be simultaneously raised and lowered by means of two winches. The winches may be electric, hydraulic, or mechanical. The winches are mounted on top of each side of the dozer moldboard and are connected to the rake by cables. The winches are capable of being remotely controlled by a lever, switch, button, knob or other suitable control mechanism located at the operator's seat. When the land clearing rake is deployed, the teeth project beyond the lower edge of the moldboard. During the raking operation, the earth moving equipment moves forward with the moldboard in a lowered position so that the teeth dig into the surface to be raked.

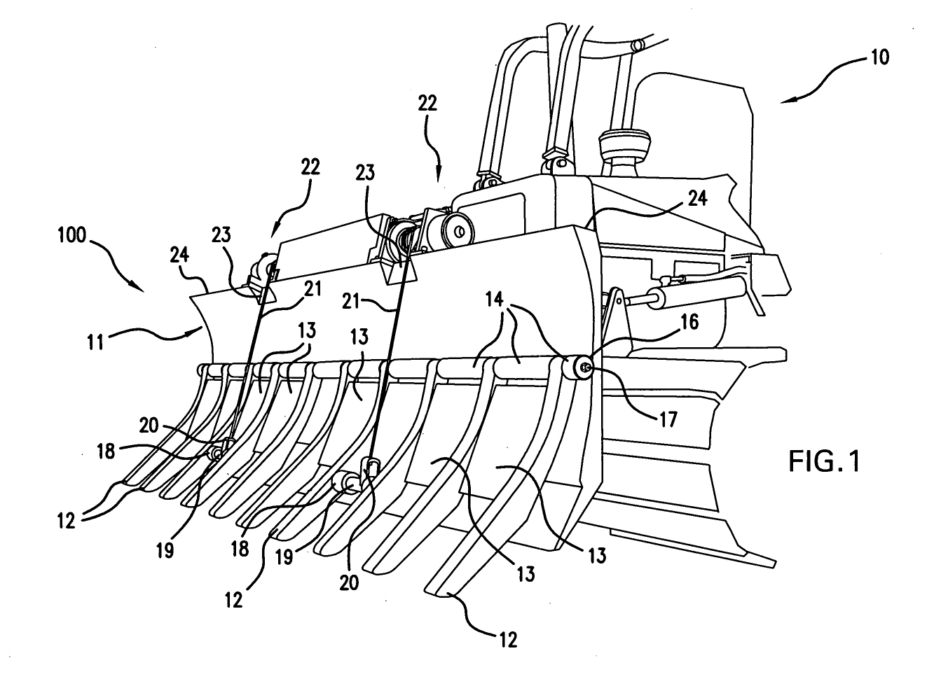

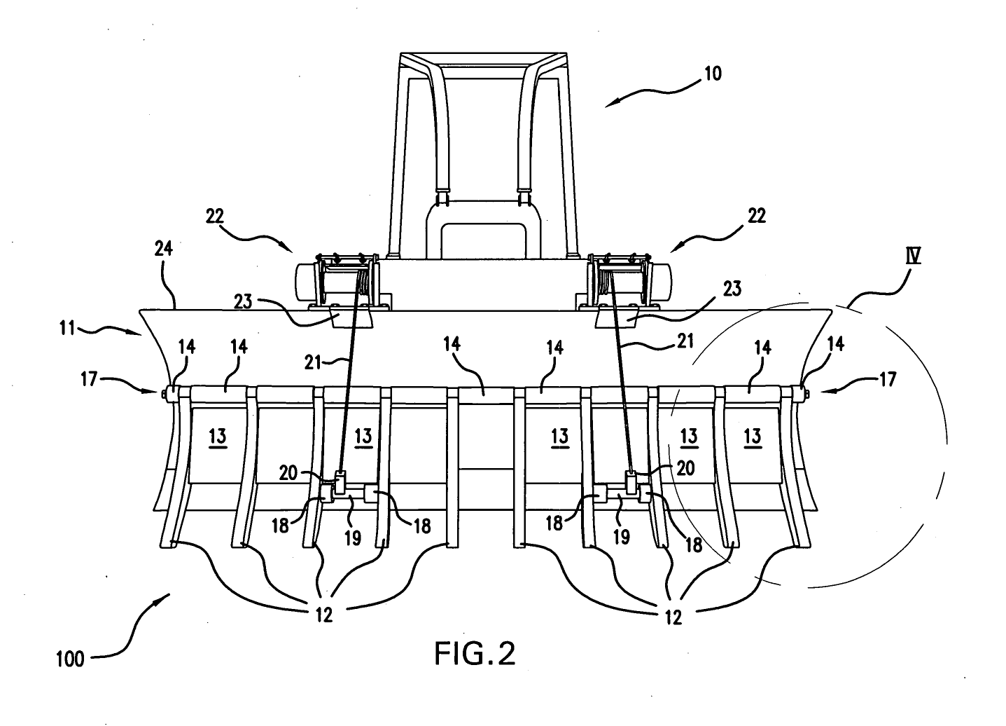

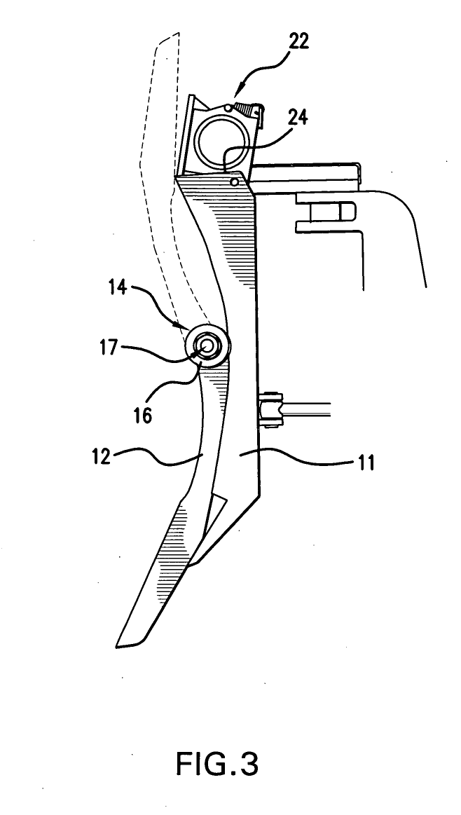

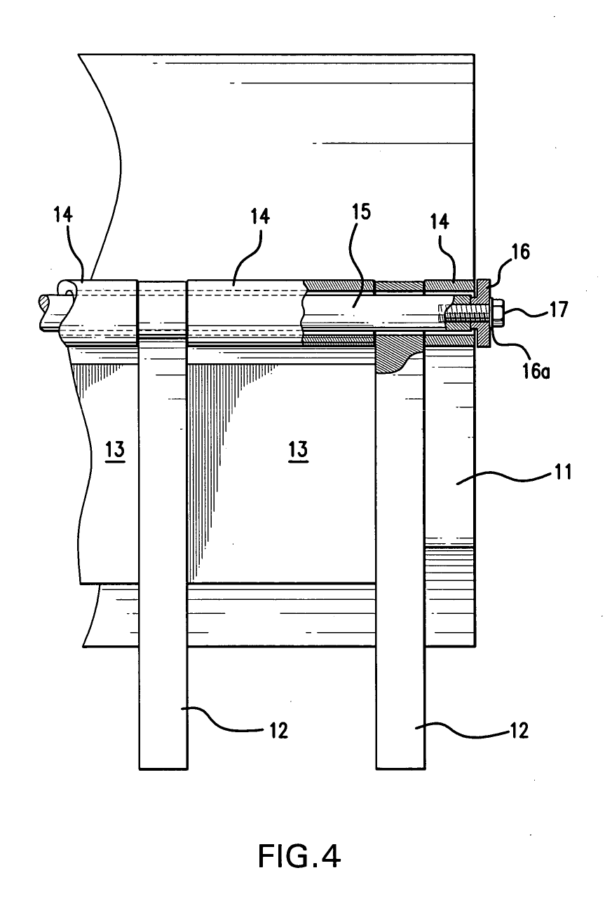

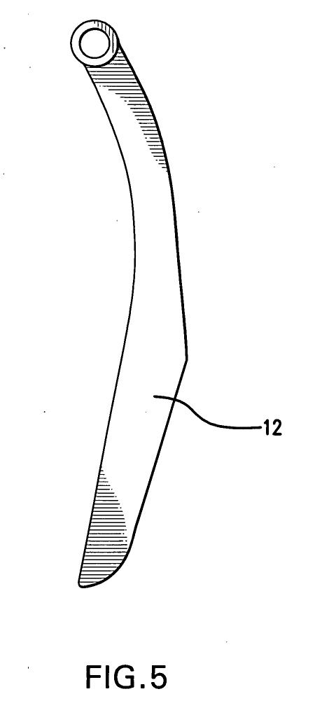

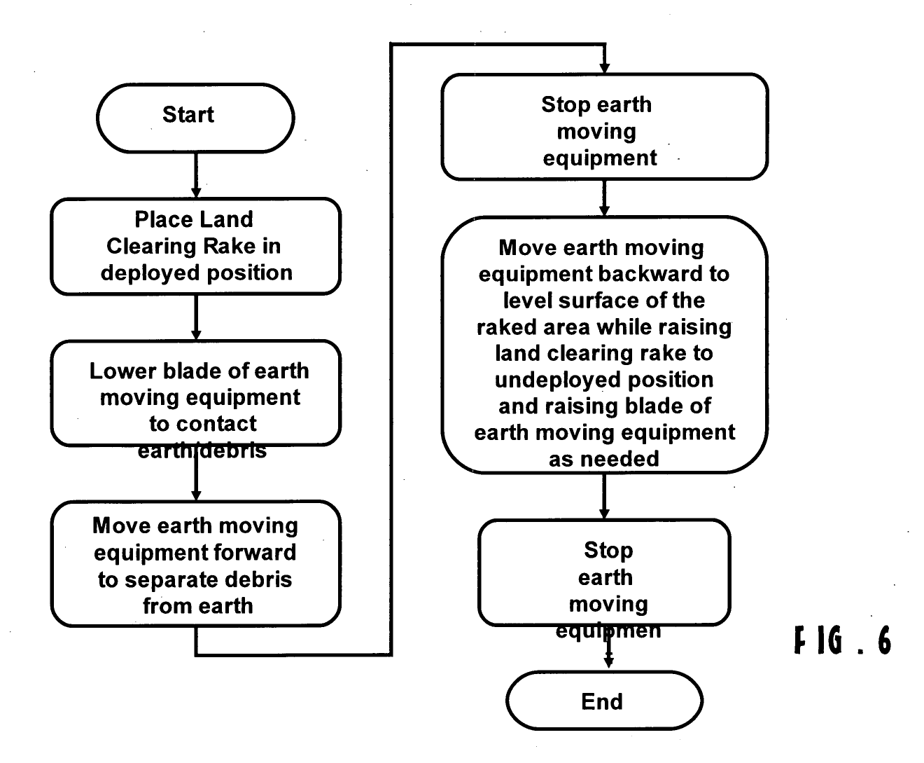

A land clearing rake 100, as illustrated in FIGS. 1-5, is installed on a conventional bulldozer 10, according to some embodiments. FIG. 1 is an isometric view of a land clearing rake mounted on a bulldozer moldboard in the deployed position, according to some embodiments. FIG. 2 is a frontal view of the land clearing rake (of FIG. 1) mounted on a bulldozer moldboard in the deployed position, according to some embodiments. FIG. 3 is a two-dimensional side view of the land clearing rake (of FIG. 1) mounted on a bulldozer moldboard in the deployed position (with dashed lines illustrating the undeployed position), according to some embodiments. FIG. 4 is a cutaway view of the right side (as viewed from the front of the bulldozer) of the interface between the tubular mounting sleeve assembly and shaft, according to some embodiments. FIG. 5 is a side view of a typical tooth on the land clearing rake, according to some embodiments. FIG. 6 is a flow diagram for a method to perform a land clearing operation using the land clearing rake.

As shown in FIGS. 1-5, the land clearing rake 100 includes teeth 12, plates 13, a tubular mounting sleeve assembly 14, a shaft 15, shouldered washers 16, lock washers 16a, bolts 17, bushings 18, cable swivel shafts 19, brackets 20, cables 21, winches 22, and moldboard cutouts 23, according to some embodiments. Elements 12, 13, 14, 15, 16, 16a, 17, 18, 19, 20, 21, and 22 are metal, although any or all of these elements may alternately be composed of steel, tin, copper, or some composite material including an amalgam of different metals or materials.

Referring specifically to FIG. 1, the land clearing rake 100 is attached to the bulldozer 10 that includes a vertically movable moldboard 11 or blade. According to some embodiments, the land clearing rake 100 is constructed of two sections, each of which includes several teeth 12 fastened to each other by plates 13. The relative sizes and shapes of teeth 12 and plates 13 may be modified as needed for a variety of applications, including but not limited to land clearing, snow/ice removal, sand work, gravel work, timber work, and mining.

The sections of the land clearing rake are pivotally connected to the moldboard 11 by the shaft 15 (Ref. FIG. 4) that passes through the tubular mounting sleeve assembly 14 as well as through the holes located at the top end of the teeth 12 (Ref. FIGS. 4 and 5). The tubular mounting sleeve assembly 14 is fastened to the moldboard 11 at the midsection of the moldboard 11; however, in some embodiments, the tubular mounting sleeve assembly may be mounted at a position near the midsection of the moldboard 11 (i.e. within 12 inches of the centerline of the moldboard). The shaft 15 is contained in the tubular mounting sleeve assembly 14 by shouldered washers 16, lock washers 16a, and bolts 17 (FIG. 4).

Two bushings 18 contain each of the cable swivel shafts 19. Cable brackets 20 secured to the cable swivel shafts 19 are used to attach cables 21 to each section of the land clearing rake 100. The cables 21 are attached to the cable brackets 20 by buttons or other suitable means and are secured to the drums of winches 22. In some embodiments, the cables 21 may be replaced by ropes or chains.

The winches 22 are mounted securely to a top planar surface 24 available on the moldboard 11. The brackets 20 are situated near the outer regions of the cable swivel shafts 19 and the cables 21 are wound around the innermost region of the drum on each winch 22 (i.e. from the inside of the drum to the outside of the drum). This configuration helps ensure that the cables 21 feed properly onto the drums of the winches 22. In addition, the components of the land clearing rake 100 are designed so that the brackets 20 are as near horizontal as possible when the land clearing rake 100 is in the undeployed position. The moldboard cutouts 23 provide an unobstructed path for the cables 21 during all phases of operation.

FIG. 2 shows the land clearing rake 100 in the undeployed position as viewed from directly in front of the bulldozer 10, according to some embodiments. From this perspective, it is apparent that the land clearing rake 100 is made up of two sections. In particular, this view shows that the two middle teeth 12 of the land clearing rake 100 are not connected. According to this embodiment, each section of the land clearing rake 100 is independently manipulated by the cable 21 and winch 22. The protrusion of the teeth 12 below the lower edge of the moldboard 11 is also shown in this view.

FIG. 3 depicts the land clearing rake 100 in the deployed and undeployed positions. The undeployed position is illustrated by the dashed lines. In the deployed position, the teeth 12 extend beyond the lower edge of the moldboard 11. In the undeployed position, the teeth 12 extend beyond the upper edge of the moldboard 11. The shouldered washer 16 and the bolt 17 are also visible in FIG. 3.

The deployed position is accomplished by lowering the teeth 12 and plates 13 against the moldboard 11 using the winches 22 to unwind the cables 21. As the cables 21 unwind, the weight of the teeth 12 and plates 13 provides the force necessary to position the land clearing rake assembly 100 in the deployed position. Thus, the teeth 12 are held against the moldboard by gravity when the teeth 12 are not in contact with earth, rocks, and debris. In this position, the cables 21 are ideally held taught enough to keep the brackets 20 positioned near vertical. This ensures that the cables 21 stay properly positioned on the drums of the winches 22. When the earth moving equipment is moving forward and the teeth 12 are in contact with earth, rocks, and debris, the teeth 12 are forced against the moldboard 11 by the earth, rocks, and debris. When the earth moving equipment is moving backward, the teeth 12 are free to move away from the moldboard 11 if they are in contact with the earth, rocks, and debris. In many applications, the operator of the earth moving equipment could either raise the land clearing rake 100 while making a backward move or leave the land clearing rake 100 in the deployed position while moving backward.

The undeployed position is accomplished by using the winches 22 to wind the cables 21 onto the drums of the winches 22. The cables 21 are positioned such that the cables 21 initially wrap around the inboard area of the drums on the winches 22 and progress outwardly. Moldboard cutouts 23 provide unobstructed paths to allow the cables to move transversely as needed to wrap around the drums of the winches 22. The brackets 20, cable swivel shafts 19, and bushings 18 are pulled up toward the winches 22, as the winches 22 wind in more of the cables 21. As a result, the lower ends of the teeth 12 are raised upward and the pivotal ends of the teeth 12 rotate with the shaft 15. As the assembly moves toward the undeployed position, the brackets 20 are continuously aligned with the cables 21 and point directly toward the winches 22 because the brackets 20 and the cable swivel shafts 19 rotate freely inside the bushings 18. When the assembly is in the undeployed position, the teeth 12 are firmly pressed against the upper edge of moldboard 11; the brackets 20 are directly aligned with the cables 21 that are wound on the winches 22; and the cables 21 are taught. The result is an assembly that is firmly and securely positioned against the moldboard 11.

FIG. 4 illustrates the interface between the shaft 15, tubular mounting sleeve assembly 14, teeth 12, shouldered washer 16, lockwasher 16a, and bolt 17. This interface is typical for both ends of the shaft 15. The shaft 15 is a continuous one-piece shaft that is drilled and threaded on both ends. The annular clearance between the shaft 15 and tubular mounting sleeve assembly 14 is great enough to allow the shaft to rotate freely in the tubular mounting sleeve assembly 14. Less annular clearance exists between the holes in the teeth 12 and the shaft 15. The different annular clearances are intended to encourage the teeth 12 to rotate with the shaft 15 so that the rotation and the corresponding frictional forces on the assembly are distributed across a greater surface area (i.e. the area between the shaft 15 and the tubular mounting sleeve assembly 14). The result is lower frictional forces on the mechanism at the interfaces between the teeth 12 and the shaft 15. This serves to reduce the wear on the mechanism at these interfaces and increases the operational life of the teeth 12 and shaft 15.

The shaft 15 is slightly shorter than the tubular mounting sleeve assembly 14. Shouldered washers 16 protrude slightly inside the tubular mounting sleeve assembly 14 and rest securely against the shaft 15 without binding against the tubular mounting sleeve assembly 14. This orientation allows the shaft 15 to float transversely a small amount. Those skilled in the art may recognize other acceptable methods of containing the shaft 15.

The outermost segments of the tubular mounting sleeve assembly 14 are significantly shorter than the inner segments. This feature allows placement of the outermost teeth 12 near the outer edges of the moldboard 11 to maximize the land clearing rake coverage area and still provide ample structural support for the teeth 12. The lengths of the components that comprise the tubular mounting sleeve assembly 14 may vary.

FIG. 5 is a side view of tooth 12 situated in the deployed configuration of the land clearing rake 100. In the deployed configuration, the convex-like side of tooth 12 rests against the moldboard 11. Accordingly, that portion of the tooth 12 is contoured to fit snugly against the moldboard 11 (Ref. FIG. 3). Therefore, this contour may vary depending upon the size and shape of the moldboard. The concave-like side of the tooth 12 is contoured to allow for efficient raking of roots and other land clearing debris. The concave-like side of the tooth 12 is also contoured to provide the structural support needed to perform the land clearing function. The hole at the upper end of the tooth 12 is present to allow the shaft 15 to pass through the tooth 12 (Ref. FIG. 4). Other shapes of the tooth 12 may be employed to enhance the function of the land clearing rake 100. For example, special tooth 12 shapes may be developed and utilized to allow the land clearing rake assembly 100 to move snow, ice, sand or gravel, etc.

FIG. 6 is a process flow diagram that illustrates a method for clearing land using the land clearing rake, according to some embodiments. Most land clearing is accomplished by moving earth moving equipment forward then backing a distance to begin another forward move. The land clearing rake is advantageous because it provides a method for an operator to utilize both the forward and backward moves to perform a function, thereby increasing the efficiency of a land clearing operation. For example, it is advantageous if the forward move of the earth moving equipment is used to rake earth and debris while the backward move of the earth moving equipment is used to back drag and somewhat smooth the surface. In order to attain this efficiency, the land clearing rake is capable of being quickly raised or lowered by the operator while the earth moving equipment is moving back to prepare for another forward move. With this capability, the operator of the earth moving equipment can effectively back drag for a degree of leveling while simultaneously raising or lowering the land clearing rake, thereby significantly reducing the time lost transitioning from raking to grading mode.

It is also common for bulldozer moldboards to have guards that extend above the moldboard in order to prevent limbs, roots, and other debris being pushed from failing behind the dozer moldboard. It would be advantageous if the prior art allowed the operator to firmly and rigidly secure the teeth in an undeployed location that would allow maximum utility of the conventional moldboard and serve as a debris guard in land clearing operations. The land clearing rake performs this function when positioned in the undeployed position because the cables and winches hold the assembly firmly against the moldboard when it is undeployed. Moreover, the land clearing rake does not unduly impede the operator's vision when it is in the undeployed position. While the invention has been described with respect to a limited number of embodiments, those skilled in the art will appreciate numerous modifications and variations therefrom. It is intended that the appended claims cover all such modifications and variations as fall within the true spirit and scope of the invention.

I claim:

1. A land clearing rake adapted to be secured to a moldboard on earth moving equipment, the land clearing rake comprising:
a plurality of teeth, having upper and lower ends, the teeth securely fastened to each other by plates located between the teeth, the teeth and plates being mounted on a moldboard, the moldboard comprising a top edge, a front, and a bottom edge, wherein the upper ends of the teeth are pivotally secured onto the front of the moldboard so that the lower end of the teeth protrude beyond the bottom edge of the moldboard when the land clearing rake is deployed and protrude above the top edge of the moldboard when the land clearing rake is undeployed;
one or more winches, each having a length of cable, wherein one end of the cable is secured to the drum of the winch and wrapped around the drum of the winch and the other end of the cable is connected to the land clearing rake, wherein the winch or winches are secured to the moldboard; and
a means for remotely controlling the winch or winches from an operator's seat so that the rake can be manipulated between the deployed and undeployed positions independently from any manipulation of the moldboard.

2. A land clearing rake adapted to be secured to a moldboard on earth moving equipment, the land clearing rake comprising:
One or more sections comprising a plurality of teeth, having upper and lower ends, the teeth securely fastened to each other by plates located between the teeth, the teeth and plates being mounted on a moldboard, the moldboard comprising a top edge, a front, and a bottom edge, wherein the upper ends of the teeth are pivotally secured onto the front of the moldboard so that the lower end of the teeth protrude beyond the bottom edge of the moldboard when the land clearing rake is deployed and protrude above the top edge of the moldboard when the land clearing rake is undeployed;
one or more winches, each having a length of cable, wherein one end of the cable is secured to the drum of the winch and wrapped around the drum of the winch and the other end of the cable is connected to the land clearing rake, wherein the winch or winches are secured to the moldboard; and
a means for remotely controlling the winch or winches from an operator's seat so that the rake can be manipulated between the deployed and undeployed positions independently from any manipulation of the moldboard.

3. The land clearing rake defined by claim 1 wherein the upper ends of the teeth are pivotally secured to the moldboard near the midsection of the moldboard.

4. The land clearing rake defined by claim 2 wherein the upper ends of the teeth are pivotally secured to the moldboard near the midsection of the moldboard.

5. The land clearing rake defined by claim 1 wherein the moldboard further comprises a top planar surface and the winch or winches are attached to the top planar surface of the moldboard with the winch or winches positioned laterally near the midpoint of the section to which the winch or winches are attached.

6. The land clearing rake defined by claim 2 wherein the moldboard further comprises a top planar surface and the winch or winches are attached to the top planar surface of the moldboard with the winch or winches positioned laterally near the midpoint of the section to which the winch or winches are attached.

7. The land clearing rake defined by claim 1 wherein each cable is connected to a bracket, the bracket comprising a top surface and a bottom surface, with the cable being secured to the top surface of the bracket and the bottom surface of the bracket being rigidly secured to a cable swivel shaft, the cable swivel shaft comprising two ends and a longitudinal axis, each end of the cable swivel shaft confined in a bushing to allow the cable swivel shaft to rotate about the longitudinal axis of the cable swivel shaft, with the bushings being rigidly attached to the land clearing rake assembly, thereby allowing the cable and brackets to remain aligned with the winch.

8. The land clearing rake defined by claim 2 wherein each cable is connected to a bracket, the bracket comprising a top surface and a bottom surface, with the cable being secured to the top surface of the bracket and the bottom surface of the bracket being rigidly secured to a cable swivel shaft, the cable swivel shaft comprising two ends and a longitudinal axis, each end of the cable swivel shaft confined a bushing to allow the cable swivel shaft to rotate about the longitudinal axis of the cable swivel shaft, with the bushings being rigidly attached to the land clearing rake assembly, thereby allowing the cable and brackets to remain aligned with the winch.

9. The land clearing rake defined by claim 1 wherein the teeth are pivotally secured using a plurality of tubular mounting sleeves secured onto the front of said moldboard near the midsection of said moldboard; at least one shaft housed inside said tubular mounting sleeves and occupying holes located near the top end of each of the teeth; and a means to transversely secure said shaft in said tubular mounting sleeves.

10. The land clearing rake defined by claim 2 wherein the teeth are pivotally secured using a plurality of tubular mounting sleeves secured onto the front of said moldboard near the midsection of said moldboard; at least one shaft housed inside said tubular mounting sleeves and occupying holes located near the top end of each of the teeth; and a means to transversely secure said shaft in said tubular mounting sleeves.

11. The land clearing rake defined by claim 1 wherein the plurality of teeth connected by the plates is comprised of two sections and each section is controlled independently by one winch.

12. Disposing a land clearing rake attached to a blade on earth moving equipment, the land clearing rake comprising a plurality of teeth, having upper and lower ends, the teeth securely fastened to each other by plates located between the teeth, the teeth and plates being mounted on a moldboard, the moldboard comprising a top edge, a front, and a bottom edge, wherein the upper ends of the teeth are pivotally secured onto the front of the moldboard so that the lower end of the teeth protrude beyond the bottom edge of the moldboard when the land clearing rake is deployed and protrude above the top edge of the moldboard when the land clearing rake is undeployed; one or more winches, each having a length of cable, wherein one end of the cable is secured to the drum of the winch and wrapped around the drum of the winch and the other end of the cable is connected to the land clearing rake, wherein the winch or winches are secured to the moldboard; and a means for remotely controlling the winch or winches so that the rake can be manipulated between the deployed and undeployed positions wherein the earth moving equipment is used to clear roots, small timber, and debris from land, the method comprising the steps of:
placing the land clearing rake in the deployed position;
lowering the moldboard and land clearing rake to contact the roots, small timber, debris and earth;
moving the earth moving equipment forward to separate the roots, small timber, and debris from the earth;
stopping the earth moving equipment;
moving the earth moving equipment backward to level the raked area while simultaneously raising the land clearing rake to an undeployed position and raising the moldboard of the earth moving equipment as needed; and
stopping the earth moving equipment.

13. The method of claim 12 wherein the steps are repeated as necessary to remove the roots, small timber, and debris from the earth.

14. Disposing a land clearing rake attached to a blade on earth moving equipment, the land clearing rake comprising a plurality of teeth, having upper and lower ends, the teeth securely fastened to each other by plates located between the teeth, the teeth and plates being mounted on a moldboard, the moldboard comprising a top edge, a front, and a bottom edge, wherein the upper ends of the teeth are pivotally secured onto the front of the moldboard so that the lower end of the teeth protrude beyond the bottom edge of the moldboard when the land clearing rake is deployed and protrude above the top edge of the moldboard when the land clearing rake is undeployed; one or more winches, each having a length of cable, wherein one end of the cable is secured to the drum of the winch and wrapped around the drum of the winch and the other end of the cable is connected to the land clearing rake, wherein the winch or winches are secured to the moldboard; and a means for remotely controlling the winch or winches so that the rake can be manipulated between the deployed and undeployed positions wherein the earth moving equipment is used to clear roots, small timber, and debris from land, the method comprising the steps of:
placing the land clearing rake in the deployed position;
lowering the moldboard and land clearing rake to contact the roots, small timber, debris and earth;
moving the earth moving equipment forward to separate the roots, small timber, and debris from the earth;
stopping the earth moving equipment;
moving the earth moving equipment backward to level the raked area while simultaneously raising the moldboard of the earth moving equipment as needed; and
stopping the earth moving equipment.

15. The method of claim 14 wherein the steps are repeated as necessary to remove the roots, small timber, and debris from the earth.
